(19) United States
(12) Patent Application Publication
(10) Pub. No.: US 2023/0105926 A1
(43) Pub. Date: Apr. 6, 2023

(54) LOAD DATA ANALYSIS METHOD, DEVICE AND PROGRAM

(71) Applicant: Mazda Motor Corporation, Hiroshima (JP)

(72) Inventor: Shogo SANNOMARU, Aki-gun (JP)

(21) Appl. No.: 17/945,322

(22) Filed: Sep. 15, 2022

(30) Foreign Application Priority Data
Oct. 4, 2021 (JP) 2021-163259

(51) Int. Cl. G06Q 10/06; G07C 3/00

(52) U.S. Cl. CPC G06Q 10/06315; G07C 3/005; G01N 2203/0073

(57) ABSTRACT

Provided is a load data analysis method for analyzing, based on a rainflow method, load data indicative of a load irregularly and repeatedly applied to an object. The load data analysis method comprises: a first step of acquiring a given amount of load data, and calculating a frequency/frequencies regarding a load amplitude of a load applied to the object and/or a load average, based on the rainflow method, by using load data satisfying a given condition among the given amount of load data; a second step of storing load data failing to satisfy the given condition among the given amount of load data; and a third step of combining the load data stored in the second step with newly-acquired load data to generate the given amount of load data for executing the first step, wherein the first to third steps are repeatedly executed.

### BACKGROUND OF THE INVENTION

### Field of the Invention

The present invention relates to a load data analysis method, device and program for analyzing load data indicative of a load applied to an object.

### Description of Related Art

Heretofore, there has been a technique of analyzing, based on a rainflow method (rainflow counting method), load data indicative of a load (mechanical load or stress, etc.) irregularly and repeatedly applied to an object such as any of various machines or buildings. In this technique, the load data is analyzed based on the rainflow method to calculate a frequency/frequencies regarding an amplitude in a waveform of a load applied to the object (hereinafter referred to as “load amplitude”) and/or the average value of the load (hereinafter referred to as “load average”). Typically, based on the calculate frequency/frequencies regarding the load amplitude and/or the load average, a damage value (i.e., material damage degree, or fatigue damage degree) of the object due to the load applied to the object is calculated.

For example, Patent Document 1 (WO 2016/016956) discloses a technique of estimating the cause of degradation undergone by a given device during operation, based on data acquired in a degradation period during which the device undergoes the degradation.

### BRIEF SUMMARY OF THE INVENTION

### Technical Problem

However, in a conventional technique, the entirety of load data over a long period of time (i.e., entire time-series load waveform) is collected and stored once, whereafter the entire time-series load waveform is analyzed by the rainflow method. Thus, a large memory capacity is necessary for recording such a vast amount of load data, and it needs to take a long time for computation because the vast amount of load data is subj ected to batch processing. Moreover, in such a conventional technique, only the load data collected over a long period of time can be analyzed, but load data acquired from moment to moment cannot be analyzed in real time.

The present invention has been made to solve the above problem of the conventional technique, and an object thereof is to provide a load data analysis method, device and program which are capable of, when analyzing, based on a rainflow method, load data indicative of a load applied to an object, adequately realizing reduction of memory capacity, shortening of computational time, and real-time analysis.

### Solution to Problem

In order to achieve the above object, according to the present invention, there is provided a load data analysis method for analyzing load data indicative of a load irregularly and repeatedly applied to an object, based on a rainflow method, comprising: a first step of acquiring a given amount of load data, and calculating a frequency/frequencies regarding an amplitude in a waveform of the load applied to the object and/or an average value of the load, by using load data satisfying a given condition among the given amount of load data, based on the rainflow method; a second step of storing load data failing to satisfy the given condition among the given amount of load data; and a third step of combining the load data stored in the second step with newly-acquired load data to generate the given amount of load data for executing the first step, wherein the first to third steps are repeatedly executed.

According to the present invention, only the given amount of load data is processed, instead of collecting load data over a long period of time and professing such a vast amount of load data, so that it is possible to realize reduction of memory capacity and shortening of computational time, when analyzing load data based on the rainflow method. Further, according to the present invention, the processing of: using the load data satisfying the given condition for calculation of the frequency/frequencies; and combining the load data failing to satisfy the given condition with newly-acquired load data to create a new given amount of load data, and using the new given amount of load data for the next calculation of the frequency/frequencies is repeated, so that it is possible to analyze load data acquired from moment to moment in real time, while ensuring computational accuracy substantially equal to that of the conventional rainflow method. As above, in the load data analysis method according to the first aspect of the present invention, it is possible to, when analyzing load data based on the rainflow method, adequately realize reduction of memory capacity (memory saving), shortening of computational time (high-speed computation) and real-time analysis, while ensuring computational accuracy substantially equal to that of the conventional rainflow method.

In the present invention, it is preferable that, in the second step, when an amount of the load data failing to satisfy the given condition among the given amount of load data is equal to or greater than a limit amount, a part of the given amount of load data is deleted such that an amount of load data to be stored becomes less than the limit amount, and then remaining load data after the deletion is stored.

According to the above present invention, the number of pieces of load data to be stored in the second step is maintained at less than the limit amount, so that it is possible to reliably generate a new given amount of load data by newly-acquired load data, in the third step.

In the present invention, it is preferable that, in the second step, when the amount of the load data failing to satisfy the given condition among the given amount of load data is equal to or greater than the limit amount, a temporally later-acquired part of the given amount of load data is deleted such that an amount of load data to be stored becomes less than the limit amount.

According to the above present invention, among the given amount of load data, load data acquired temporally later, i.e., load data having a relatively small load amplitude, is deleted, so that it is possible to minimally suppress an influence (error) due to the deletion of load data.

In the present invention, it is preferable that the load data analysis method further comprises a fourth step of calculating peak data corresponding to a point at which a change in the load data switches from increasing to decreasing, or from decreasing to increasing, wherein, in the first to third steps, the peak data calculated in the fourth step is used as load data serving as a processing target in each step, and wherein, in the third step, when a relationship between first peak data which is temporally latest among peak data corresponding to the load data stored in the second step and second peak data which is temporally earliest among peak data corresponding to the newly-acquired load data does not satisfy a condition that increasing and decreasing of the peak data occur alternately, the first peak data is overwritten with the second peak data to generate the given amount of load data for executing the first step.

According to the above present invention, it is possible to, when combining the load data stored in the second step with the newly-acquired load data, adequately generate a new given amount of load data in which increasing and decreasing of the load data (peak data) occur alternately, and utilize the rainflow method in an appropriate manner.

In the present invention, it is preferable that the load data analysis method further comprises a fourth step of calculating peak data corresponding to a point at which a change in the load data switches from increasing to decreasing, or from decreasing to increasing, wherein, in the first to third steps, the peak data calculated in the fourth step is used as load data serving as a processing target in each step, and wherein, in the first and second steps, with regard to adjacent peak data calculated in the fourth step, comprising first peak data, second peak data subsequent to the first peak data, and third peak data subsequent to the second peak data, a condition that a difference between the second peak data and the third peak data is equal to or greater than a difference between the first peak data and the second peak data is used as the given condition.

According to the above present invention, it is possible to reliably apply load data having a relatively large amplitude to calculation of the frequency/frequencies regarding the load amplitude and/or the load average.

In the present invention, it is preferable that the load data analysis method further comprises a fifth step of calculating a damage value of the object due to the load applied to the object, based on at least the frequency/frequencies calculated in the first step.

According to the above present invention, it is possible to calculate a highly-accurate damage value in real time, while ensuring reduction of memory capacity and shortening of computational time.

In the present invention, it is preferable that the load data analysis method is executed by a processing unit mounted on a vehicle to analyze load data corresponding to a load applied to a component of the vehicle.

According to the above present invention, it is possible to accurately analyze load data applied to a component of the vehicle, even with a relatively small memory capacity used in vehicles. Further, it is possible to analyze load data applied to a component of the vehicle in real time.

In the present invention, it is preferable that the load data analysis method further comprises a sixth step of displaying the frequency/frequencies calculated in the first step or information related to the frequency/frequencies.

According to the above present invention, it is possible to adequately inform a user of the frequency/frequencies regarding the load amplitude and/or the load average, or information related to the frequency/frequencies (e.g., a damage value, information depending on the damage value, or the like).

In order to achieve the above object, according to another aspect of the present invention, there is provided a load data analysis device for analyzing load data corresponding to a load irregularly and repeatedly applied to an object, based on a rainflow method, the load data analysis device is configured to execute processing comprising: a first step of acquiring a given amount of load data, and calculating a frequency/frequencies regarding an amplitude in a waveform of the load applied to the object, and/or an average value of the load, by using load data satisfying a given condition among the given amount of load data, based on the rainflow method; a second step of storing load data failing to satisfy the given condition among the given amount of load data; and a third step of combining the load data stored in the second step with newly-acquired load data to generate the given amount of load data for executing the first step, wherein the first to third steps are repeatedly executed.

In order to achieve the above object, according to still another aspect of the present invention, there is provided a load data analysis program to be executed by a computer device for analyzing load data corresponding to a load irregularly and repeatedly applied to an object, based on a rainflow method, the load data analysis program being configured to cause the computer device to execute processing comprising: a first step of acquiring a given amount of load data, and calculating a frequency/frequencies regarding an amplitude in a waveform of the load applied to the object and/or an average value of the load, by using load data satisfying a given condition among the given amount of load data, based on the rainflow method; a second step of storing load data failing to satisfy the given condition among the given amount of load data; and a third step of combining the load data stored in the second step with newly-acquired load data to generate the given amount of load data for executing the first step, wherein the first to third steps are repeatedly executed.

According to the load data analysis device and the load data analysis program in the present invention, it is also possible to, when analyzing load data based on the rainflow method, adequately realize reduction of memory capacity, shortening of computational time and real-time analysis, while ensuring computational accuracy substantially equal to that of the conventional rainflow method.

As above, the load data analysis method, device and program of the present invention make it possible to, when analyzing, based on the rainflow method, load data indicative of a load applied to an object, adequately realize reduction of memory capacity, shortening of computational time and real-time analysis.

### BRIEF DESCRIPTION OF THE SEVERAL VIEWS OF THE DRAWINGS

FIG. 1 is a schematic configuration diagram of a computer device as one example of an execution subject of a load data analysis method according to one embodiment of the present invention.

FIG. 2 is an explanatory diagram of a basic calculation method for a damage value depending on a load amplitude.

FIG. 3 is an explanatory diagram of a more specific calculation method for the damage value depending on the load amplitude (Minor’s law).

FIG. 4 illustrates examples of a load amplitude histogram and a load average histogram derived from an actual time-series load waveform.

FIG. 5 is an explanatory diagram of load amplitude, load average, etc., used for a rainflow method.

FIG. 6 is an explanatory diagram of how to process a small loop in the rainflow method.

FIG. 7 is an explanatory diagram of how to process a stopped wave in the rainflow method.

FIG. 8 is an explanatory diagram of generation of peak data to be performed in the rainflow method.

FIG. 9 is an explanatory diagram of collection of a small loop to be performed in the rainflow method.

FIG. 10 is an explanatory diagram of collection of a stopped wave to be performed in the rainflow method.

FIG. 11 is an explanatory diagram regarding a reason why an unknown wave should not be directly collected in the rainflow method.

FIG. 12 is an explanatory diagram regarding the outline of computation in the load data analysis method according to this embodiment.

FIG. 13 illustrates a specific example of load data within a computational region used in the load data analysis method according to this embodiment.

FIG. 14 is an explanatory diagram of small loop collection and stopped wave collection with respect to the load data within the computational region, in the load data analysis method according to this embodiment.

FIG. 15 is an explanatory diagram regarding insertion of new load data into a vacant space within the computational region, in the load data analysis method according to this embodiment.

FIG. 16 illustrates a specific example of the number of unknown waves occurring in each step, in the load data analysis method according to this embodiment.

FIG. 17 is an explanatory diagram regarding deletion of a part of load data of an unknown wave, in the load data analysis method according to this embodiment.

FIG. 18 is an explanatory diagram regarding a problem occurring when connecting an unknown wave to new load data.

FIG. 19 is an explanatory diagram regarding overwriting of the load data of an unknown wave with new load data.

FIG. 20 is a flowchart showing the load data analysis method according to this embodiment.

FIG. 21 shows an experimental result about a memory capacity used and an error in damage value, in the load data analysis method according to this embodiment.

FIG. 22 shows an experimental result about a memory capacity used and a computation time, in the load data analysis method according to this embodiment.

FIG. 23 shows an experimental result about respective damage values in the load data analysis method according to this embodiment and in the conventional rainflow method.

### DETAILED DESCRIPTION OF THE INVENTION

With reference to the accompanying drawings, a load data analysis method, device and program according to the present invention will be described.

### Computer Device

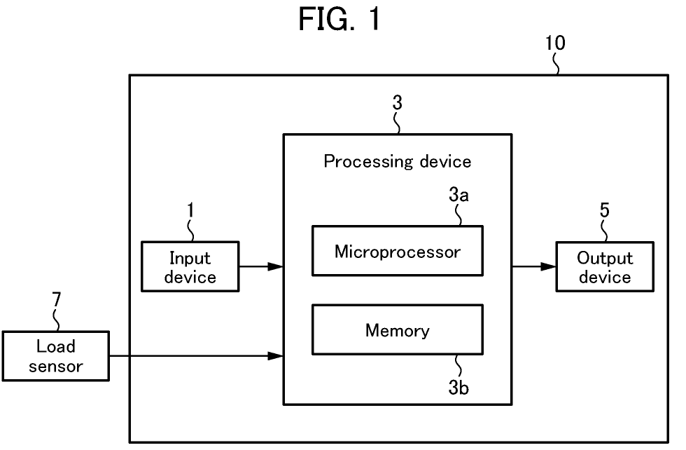

First of all, with reference to FIG. 1, a computer device which is one example of an execution subject of a load data analysis method according to one embodiment of the present invention will be described. As shown in FIG. 1, the computer device 10 mainly comprises an input unit 1 configured to allow a user or the like to input information therethrough, a processing unit 3 configured to process various pieces of information, and an output unit 5 configured to output information therefrom.

The input unit 1 is composed of, e.g., a mouse, a keyboard, and/or a microphone, and the output unit 5 is composed of, e.g., a display unit and/or a speaker. The processing unit 3 comprises: one or more microprocessors 3a serving as a central processing unit (CPU) for executing a program; and a memory 3b comprising a RAM (Random Access Memory), a ROM (Read Only Memory) and/or a hard disk, and storing therein a program and data.

Further, a load sensor 7 for detecting a load irregularly and repeatedly applied to a given object is connected to the computer device 10, so that load data corresponding to a load detected by the load sensor 7 is input to the computer device 10 (particularly to the processing unit 3). The load sensor 7 is configured to detect a load corresponding to a mechanical load or stress, etc., applied to the given object. For example, the load sensor 7 is composed of a strain gauge installed on the given object.

The load data analysis method according to this embodiment is executed by the processing unit 3 of the computer device 10. Specifically, the memory 3b of the processing unit 3 stores therein a program corresponding to the above load data analysis method (i.e., the load data analysis program according to the present invention), and the one or more microprocessors 3a of the processing unit 3 are operable to read out the load data analysis program from the memory 3b and execute the load data analysis program. Thus, the computer device 10 (particularly, processing unit 3) functions as the load data analysis device according to the present invention.

In this embodiment, the computer device 10 (processing unit 3) is operable to acquire, from the load sensor 7, load data indicative of a load irregularly and repeatedly applied to an object such as any of various machines or buildings, and analyze the acquired load data based on a rainflow method. Specifically, in this embodiment, the computer device 10 is operable to, through the analysis of the load data based on the rainflow method, calculate frequencies regarding a load amplitude (i.e., the amplitude in a waveform of the load applied to the object) and a load average (i.e., the average value of the load), and, based on the frequencies of the load frequency and the load average, calculate a damage value (material damage degree, or fatigue damage degree) of the object due to the load applied to the object.

For example, the computer device 10 is comprised of a processing unit (such as an electronic control unit (ECU)) mounted on a vehicle, and is operable to analyze a load applied to a given component of the vehicle. In one example, the computer device 10 is operable to analyze a load applied to a gear case of a transmission to which an engine torque is input, a motor case of an electric vehicle (EV), or the like. In this case, the aforementioned strain gauge serving as the load sensor 7 is installed on a component of the vehicle to which a load to be analyzed by the computer device 10 is applied.

### Damage Value Calculation Method

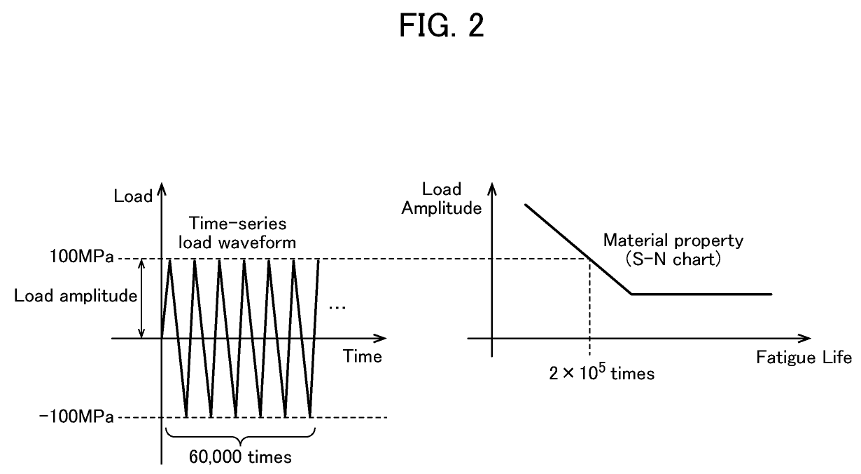

Next, with reference to FIGS. 2 to 4, a commonly-used damage value calculation method will be described. FIG. 2 is an explanatory diagram of a basic calculation method for a damage value depending on the load amplitude. A temporal change of a load (stress) applied to the given object, i.e., a time-series load waveform is illustrated on the left side of FIG. 2. Here, a case is exemplified in which a load having an amplitude of 100 Mpa has been applied to the object 60,000 times, i.e., a load amplitude of 100 Mpa has occurred 60,000 times. An S-N chart representing a relationship between load amplitude and fatigue life (material property) is illustrated on the right side of FIG. 2. This S-N chart shows that when the load amplitude is 100 Mpa, the material breaks (fractures) after 2 × 10⁵ times. Here, in the above case where a load amplitude of 100 Mpa has occurred 60,000 times, a damage value D is calculated as follows: “D = 60,000 /(2 × 10⁵) = 0.3”. Since the material breaks when the damage value D is 1, this value shows that the material reaches a condition which is 30% with respect to 100% of a breaking condition.

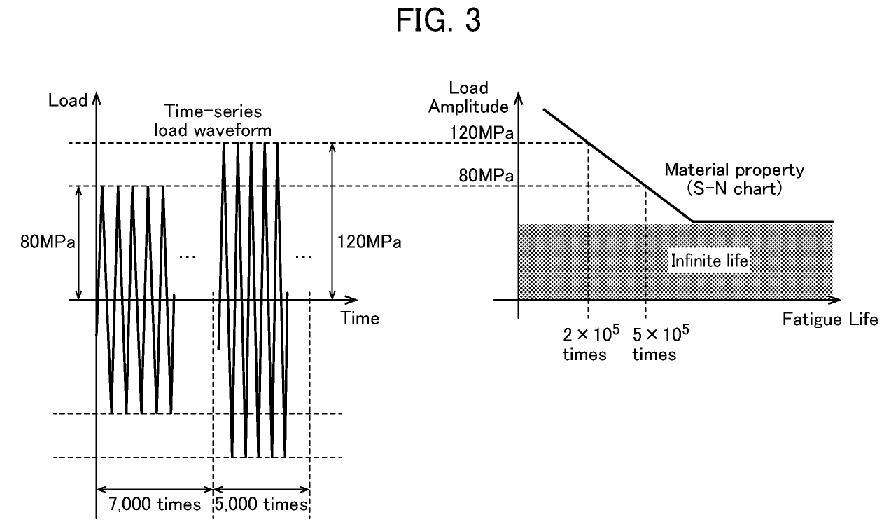

FIG. 3 is an explanatory diagram of a more specific calculation method for the damage value depending on the load amplitude (Minor’s law). A time-series load waveform is illustrated on the left side of FIG. 3. Here, a case is exemplified in which a load amplitude of 80 Mpa and a load amplitude of 120 Mpa have occurred 7,000 times and 5,000 times, respectively. An S-N chart representing a relationship between load amplitude and fatigue life (material property) is illustrated on the right side of FIG. 3. This S-N chart shows that, for example, when the load amplitude is 80 Mpa, the material breaks after 5 × 10⁵ times, and when the load amplitude is 120 Mpa, the material breaks after 2 × 10⁵ times. Here, in the above case where a load amplitude of 80 Mpa has occurred 7,000 times, and a load amplitude of 120 Mpa has occurred 5,000 times, a damage value DA due to the fact that a load amplitude of 80 Mpa has occurred 7,000 times is calculated as follows: “DA = 7,000 / (5 × 10⁵) = 0.014”, and a damage value DB due to the fact that a load amplitude of 120 Mpa has occurred 5,000 times is calculated as follows: “DB = 5,000 / (2 × 10⁵) = 0.025”. Thus, a total (ultimate) damage value D is calculated as follows: “DA + DB = 0.014 + 0.025 = 0.039”. The above damage value calculation method is based on the Minor’s law.

From what is described in FIG. 3, it can be said that even when a load having a complicated waveform is applied, the damage value can be calculated by analyzing the load waveform and deriving the load amplitude, load average, and cycle number (i.e., frequency). It should be noted that, although FIGS. 2 and 3 show examples where the load average is approximately zero (i.e., examples where a positive peak value and a negative peak value in the load waveform are approximately the same in absolute value) for the sake of simplification of explanation, the load average is not zero in actual load waveforms. Since this load average exerts influence on the damage value, separately from the load amplitude, it is necessary to derive the load average when calculating the damage value. Typically, the load average is a median value of adjacent peak values (higher and lower peak values) in the load waveform.

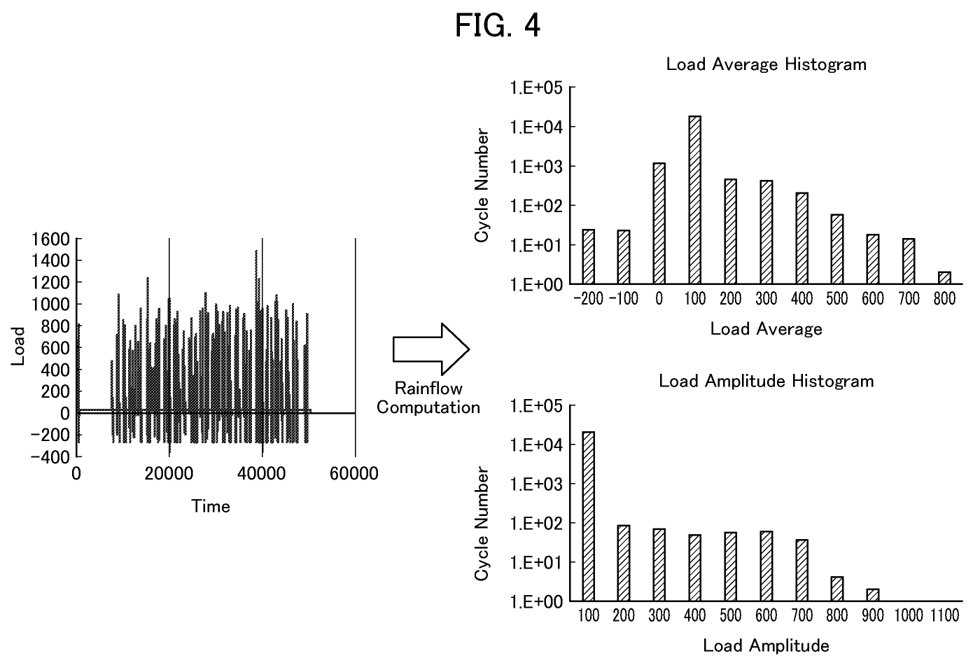

An example of respective frequencies (cycle numbers) of the load amplitude and the load average derived from an actual time-series load waveform from this standpoint is shown in FIG. 4. One example of a waveform regarding a load applied to an object over a long period of time (time-series load waveform) is illustrated on the left side of FIG. 4, and two histograms each representing a respective one of the frequencies of the load amplitude and the load average obtained by analyzing the time-series load waveform are illustrated on the right side of FIG. 4. Specifically, the load amplitude and load average histograms are derived by analyzing the time-series load waveform by a rainflow method (the details thereof will be described later). Then, a total damage value can be calculated, based on the Minor’s law, using various values of the load amplitude and the load average, and respective cycle numbers for the various values of the load amplitude and the load average, obtained from the load amplitude and load average histograms derived in the above, and the S-N chart.

### Rainflow Method

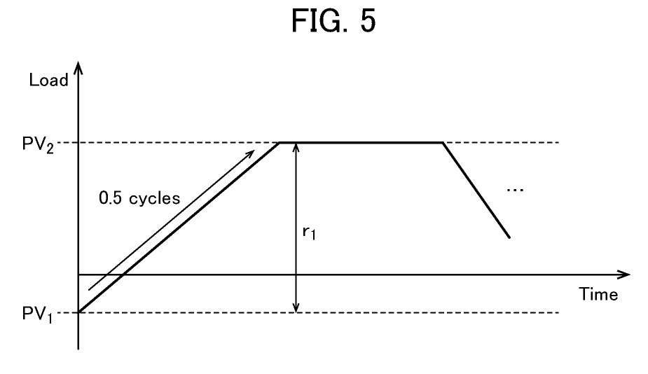

Next, with reference to FIGS. 5 to 7, a basis concept of a commonly-used rainflow method will be described. FIG. 5 is an explanatory diagram of the load amplitude, the load average, etc., used for the rainflow method. FIG. 5 shows a portion of a load waveform applied to an object, corresponding to about a 0.5 cycle. Each of the reference signs PV₁ and PV₂ denotes a value corresponding to a peak (a point at which a change in the load waveform switches from increasing to decreasing, or from decreasing to increasing) of the load waveform (i.e., a peak value of the load waveform). Further, the 0.5 cycle denotes an interval between the adjacent peak values PV₁ and PV₂. In the rainflow method, computation is performed based on the peak values PV₁ and PV₂ of the load waveform. In this case, the load average is defined as “(PVi and PV₂) / 2”, and the load amplitude (particularly, load half-amplitude) is defined as “n/2”, using a difference r₁ between the peak values PV₁ and PV₂ (r₁ = | PV₁ - PV₂ |) (the difference hereinafter be referred to as “PV difference”).

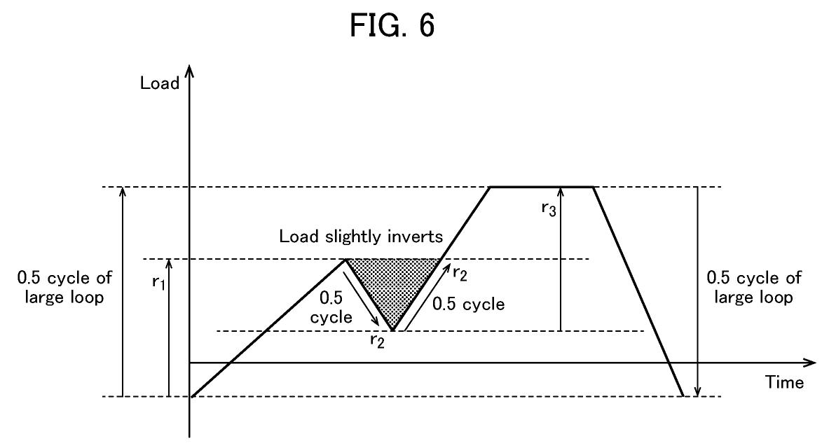

FIG. 6 is an explanatory diagram of how to process a small loop existing in a load waveform, in the rainflow method. FIG. 6 shows a load waveform having a plurality of peaks. In this load waveform, a small loop (0.5 cycle) in which load slightly changes (inverts) exists in a loop (0.5 cycle) in which load largely changes. In the rainflow method, such a small loop is also used for computation, i.e., “collected”, without being ignored. This makes it possible for the rainflow method to ensure high computational accuracy. As used in this specification, the term “collect” means, in the rainflow method: updating (accumulating) the load amplitude and load average histograms, based on data about a load waveform (i.e., load data, specifically, peak data); updating (accumulating) the damage value; and after these processings, deleting the data.

Further, a condition for the small loop (hereinafter referred to as “small loop condition”, as appropriate) is defined as “| r₁ | > | r₂ | ≤ | r₃ |”, using adjacent three PV differences r₁, r₂, r₃ in the load waveform. In the example illustrated in FIG. 6, since the PV difference r₂ satisfies the small loop condition, this wave is collected. During this collection, the PV differences r₂, r₃ are removed. Specifically, the following processing is performed: “| r₁ | ← | r₃ | - | r₂ | + | r₁ |”.

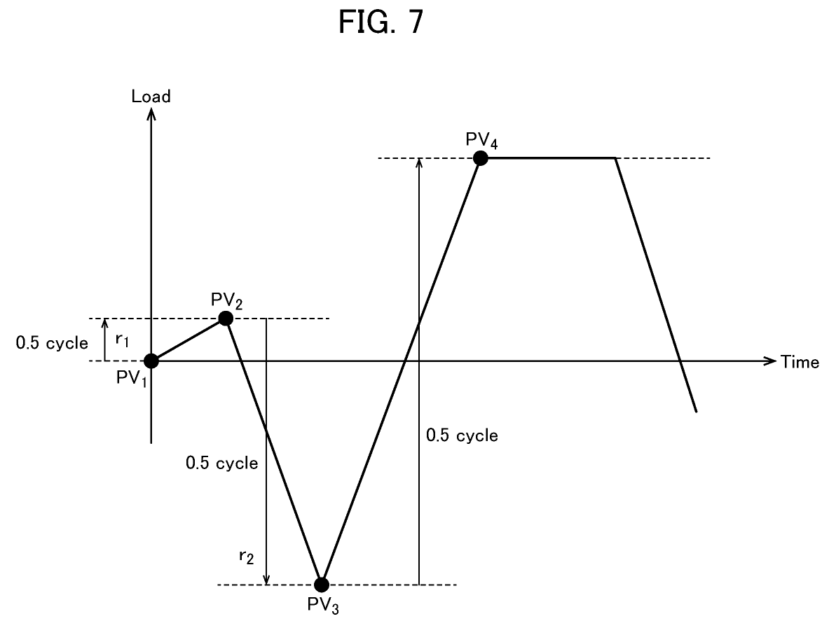

FIG. 7 is an explanatory diagram of a stopped wave in the rainflow method. FIG. 7 also shows a load waveform having a plurality of peaks, particularly a load waveform having four peak values PV₁, PV₂, PV₃, PV₄. In this load waveform, since an amplitude from the peak value PV₃ to the peak value PV₄ is greater than an amplitude from the peak value PV₁ to the peak value PV₄, it is necessary to reliably collect the former amplitude. For this reason, in the rainflow method, in order to prioritize collection of the larger amplitude, an amplitude starting from the peak value PV₁ is stopped at the peak value PV₂. Specifically, in the rainflow method, a load wave directed from the peak value PV₁ toward the peak value PV₂ is defined as a stopped wave, and processing for the above collection is performed under this stopped wave. That is, the stopped wave is defined to reliably perform the collection processing. In this case, a condition for the stopped wave (hereinafter referred to as “stopped wave condition”, as appropriate) is defined as “| r₂ | ≥ | r₁ |”, using adjacent two PV differences r₁, r₂ in the load waveform.

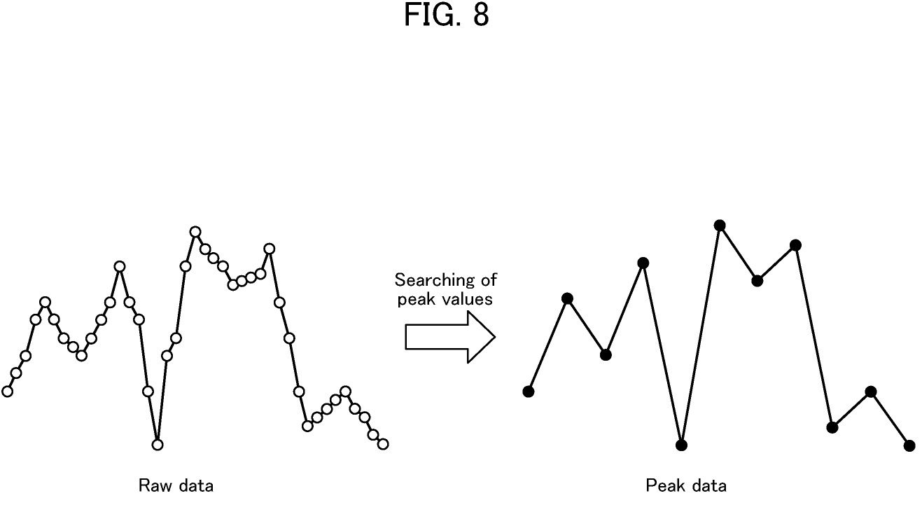

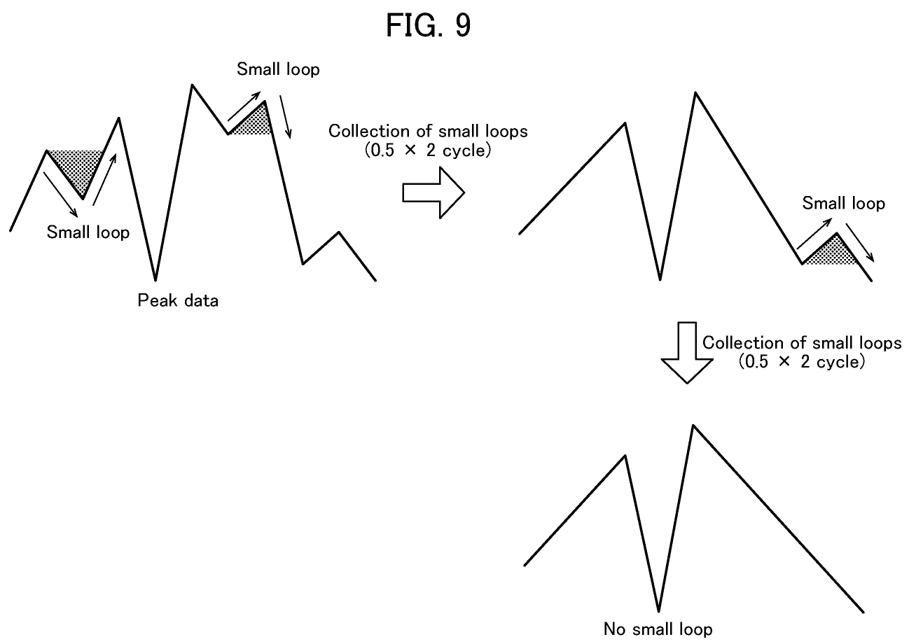

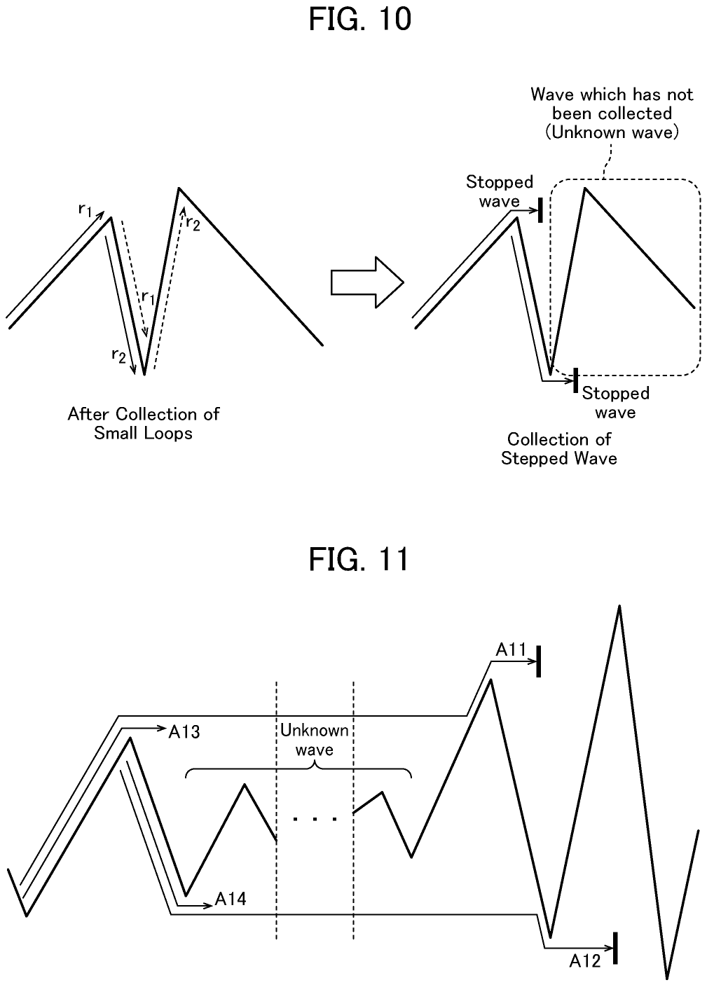

Next, with reference to FIGS. 8 to 10, the flow of a specific computation process in the commonly-used rainflow method will be described. FIG. 8, FIG. 9 and FIG. 10 are, respectively, an explanatory diagram regarding generation of peak data to be initially performed in the rainflow method, an explanatory diagram regarding collection of a small loop to be subsequently performed in the rainflow method, and an explanatory diagram regarding collection of a stopped wave to be performed in the rainflow method.

Firstly, as shown in FIG. 8, peak values are searched from to raw data of sequentially-acquired load data (time-series load waveform) to generate data consisting of the peak values (peak data). This peak data is generated by searching points (black circles in FIG. 8) at which a change in the load waveform switches from increasing to decreasing, or from decreasing to increasing. Then, as shown in FIG. 9, in the obtained peak data (FIG. 8), when a small loop is identified through the use of the small loop condition “| r₁ | > | r₂ | ≤ | r₃ |”, regarding the relationship among the adjacent three PV differences r₁, r₂, r₃, collection (including removal) of the small loop is sequentially performed. Specifically, the small loop collection will be repeated until there is no small loop in the load waveform. Then, as shown in FIG. 10, in load data with no small loop (FIG. 9), a stopped wave is identified through the use of the stopped wave condition“| r₂ | > | r₁ |”, regarding the relationship between the adjacent two PV differences r₁, r₂, collection (including removal) of the stopped wave is sequentially performed.

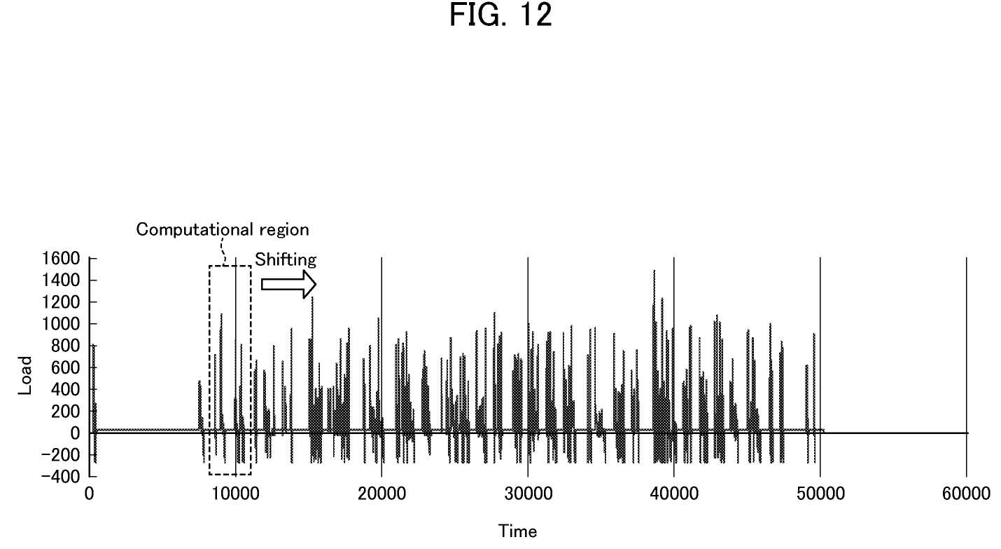

Here, since a wave surrounded by the broken line in FIG. 10 fails to satisfy the stopped wave condition, i.e., the adjacent two PV differences r₁, r₂ have the following relationship: “| r₂ | < | r₁ |”, it will be left without being collected. Such a wave which is left without being collected will hereinafter be referred to as “unknown wave”. On the other hand, a wave which is identified as a stopped wave and therefore collected will hereinafter be referred to as “known wave”. Since the unknown wave is a wave after collecting any small wave therefrom, it has a relatively large amplitude. Thus, it can be said that a wave having a significant influence on strength (intensity) will be undesirably left without being collected. Although it is conceivable that the unknown wave left in the above manner is immediately collected with its wave profile as-is, it is not desirable to do so. The reason will be described with reference to FIG. 11.

FIG. 11 is an explanatory diagram regarding a reason why an unknown wave should not be directly collected in the rainflow method. FIG. 11 shows a waveform after collecting any small loop from a load waveform, specifically peak data, obtained over a relatively long period of time. Here, a case is exemplified in which, due to a situation where no large load has been applied for a long period of time, specifically any load satisfying the stopped wave condition“| r₂ | | ≥ | r₁ |”, regarding the relationship between the adjacent two PV differences r₁, r₂, has not appeared for a long period of time, an uncollected unknown wave remains over a long period of time. After the elapse of a long period of time, when a stopped wave as indicated by the arrowed lines A11, A12 appears, this unknown wave will be collected and properly evaluated. However, if the unknown wave is collected based on a stopped wave as indicated by the arrowed lines A13, A14 (a wave prior to the unknown wave), the unknown wave will be underestimated. Thus, it can be said that the unknown wave should not be collected immediately upon its occurrence, but, after waiting until an appropriate stopped wave (a wave satisfying the stopped wave condition) appears, should be collected based on this stopped wave.

Meanwhile, in the conventional rain flow method, the entirety of load data over a long period of time is collected and stored once, whereafter the load data is analyzed. Thus, a large memory capacity is necessary for recording such a vast amount of load data, and it needs to take a long time for computation because the vast amount of load data is subjected to batch processing. Moreover, in the conventional rainflow method, only the load data collected over a long period of time can be analyzed, but load data acquired from moment to moment cannot be analyzed in real time. Therefore, the load data analysis method according to this embodiment is intended to, when analyzing load data based on a rainflow method, adequately realize reduction of memory capacity (memory saving), shortening of computational time (high-speed computation) and real-time analysis, while ensuring computational accuracy substantially equal to that of the conventional rainflow method.

### Load Data Analysis Method According to This Embodiment

Next, the load data analysis method according to this embodiment to be executed by the processing unit 3 of the computer device 10 (see FIG. 1) so as to analyze load data based on a rainflow method will be described.

Firstly, with reference to FIG. 12, the outline of computation in the load data analysis method according to this embodiment will be described. FIG. 12 shows one example of a waveform regarding a load applied to an object for a long period of time (time-series load waveform). As mentioned above, in the conventional rainflow method, the entirety of load data over a long period of time (entire time-series load waveform) is collected and stored once, whereafter the load data is analyzed. By contrast, in this embodiment, as shown in FIG. 12, the processing unit 3 of the computer device 10 operates to use a given amount of load data, i.e., use load data within a region (hereinafter referred to as “computational region”, as appropriate) which is a part of the entire time-series load waveform, instead of using the entire load data, to analyze the load data based on a rainflow method.

Conceptionally, the processing unit 3 operates to sequentially execute the rainflow method while shifting the computational region step by step, thereby sequentially collecting wave information of the load data. Actually, instead of using a computational region which is a part of the entire time-series load waveform over a long period of time, as shown in FIG. 12, the processing unit 3 operates to use a computational region obtained in real time, i.e., a computational region consisting of a plurality of pieces of load data acquired from moment to moment, to analyze the load data. More specifically, the processing unit 3 operates to sequentially analyze load data within such a computational region by the rainflow method, thereby updating (accumulating) the load amplitude and load average histograms, and updating (accumulating) the damage value.

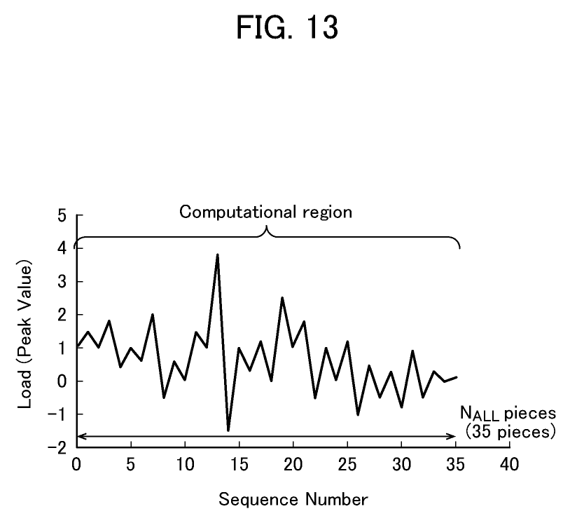

FIG. 13 illustrates a specific example of load data within the computational region used in the load data analysis method according to this embodiment. FIG. 13 shows load data corresponding to a peak value of load (i.e., peak data; hereinafter referred to as “load peak data”, as appropriate), and shows a computational region consisting of Nₐₗₗ pieces (in one example, 35 pieces) of load peak data. The horizontal axis of FIG. 13 represents a sequence number for arranging the Nₐₗₗ pieces of load peak data in time-series order. In this embodiment, the processing unit 3 operates to store only the load peak data within the computation area as shown in FIG. 13, i.e., the load peak data having Nₐₗₗ peak values, in the memory 3b, and analyze the load peak data by the rainflow method. Specifically, the processing unit 3 operates to sequentially repeat storing load peak data within a current computational region and analyzing the load peak data by the rainflow method. Here, the Nₐₗₗ pieces of load peak data are equivalent to “given amount of load data” set forth in the appended claims.

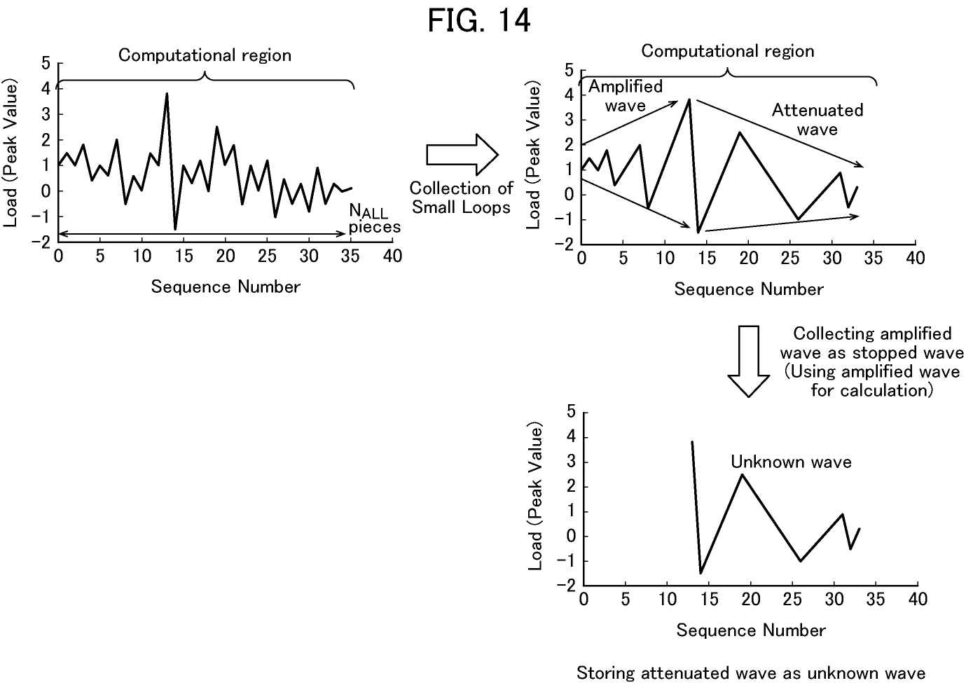

FIG. 14 illustrates a specific example of small loop collection and stopped wave collection with respect to the load data (load peak data) within the computational region, in the load data analysis method according to this embodiment. The Nₐₗₗ pieces of load peak data within the same computational region as that in FIG. 13 are illustrated on the left side of FIG. 14. When small loops in the Nₐₗₗ pieces of load peak data within the computational region are collected (with regard to the small loop collection, refer to FIGS. 6 and 9), an amplified wave whose load amplitude gradually increases and an attenuated wave whose load amplitude gradually decreases appear in the waveform of the load peak data within the computational region, as illustrated in the upper right side of FIG. 14. Generally, the amplified wave appears prior to the attenuated wave.

When the stopped wave collection is performed with respect to the load peak data after the small loop collection (with regard to the stopped wave collection, refer to FIGS. 7 and 10), the amplified wave is entirely collected, whereas the attenuated wave is left without being collected, as illustrated in the lower right side of FIG. 14. That is, since plural pieces of load peak data constituting the amplified wave satisfy the stopped wave condition “| r₂ | ≥ | r₁ |”, regarding the relationship between adjacent two PV differences r₁, r₂ in the load waveform (the stopped wave condition is equivalent to “given condition” set forth in the appended claims), they are collected as a stopped wave (known wave). On the other hand, since plural pieces of load peak data constituting the attenuated wave do not satisfy the stopped wave condition, they are left as an unknown wave without being collected. In this case, the processing unit 3 operates to: update (accumulate) the load amplitude and load average histograms, based on the plural pieces of load peak data constituting the amplified wave; update (accumulate) the damage value; and, after these processings, delete these plural pieces of load peak data without being stored. On the other hand, the processing unit 3 basically operates to store the plural pieces of load peak data constituting the attenuated wave in the memory 3b without performing computation similar to that performed for the amplified wave.

Generally, the unknown wave is an attenuated wave whose load amplitude gradually decreases. Further, the unknown wave will be collected as a stopped wave when a wave larger than the unknown wave appears after the unknown wave in the feature. Thus, the unknown wave will be stored in the memory 3b until such a large wave appears.

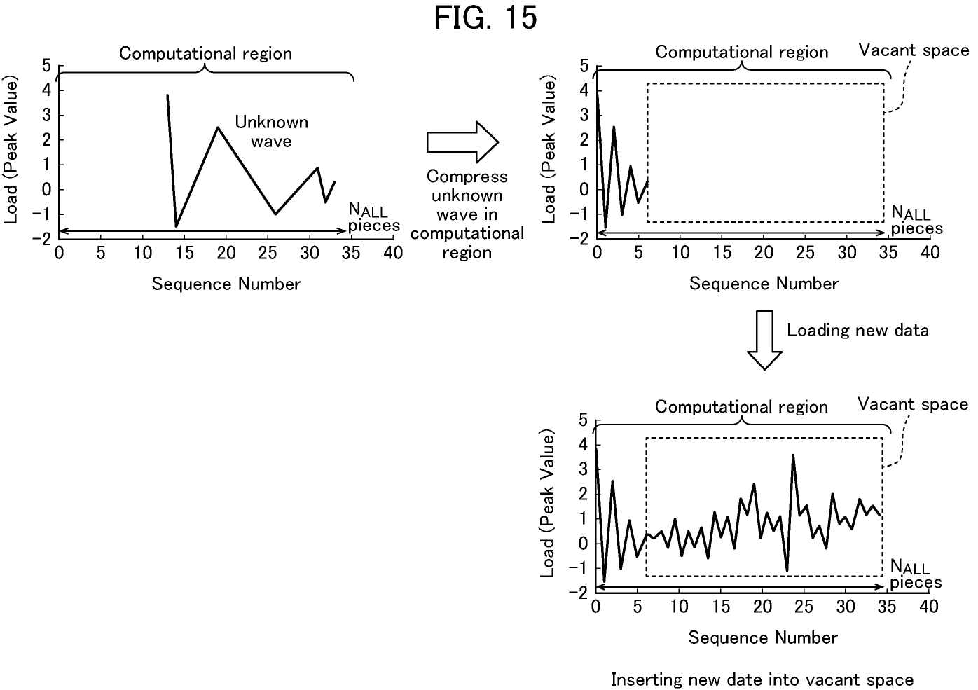

FIG. 15 is an explanatory diagram regarding processing to be performed after storing the unknown wave, in the load data analysis method according to this embodiment. The same unconfined wave as that in FIG. 14 is illustrated on the left side of FIG. 15. In this embodiment, the processing unit 3 first operates to push the unknown wave toward an earlier side of the computational region, as illustrated on the upper right side of FIG. 15. Specifically, the processing unit 3 operates to compress the unknown wave toward the left end of the computational region. In this case, the processing unit 3 operates to compress the unknown wave such that the unknown wave occupies the computational region by the ratio of the number of peak values included in the unknown wave (in the example illustrated in FIG. 15, 6 peak values) to the number of waves (Nₐₗₗ pieces) constituting the computational region. When pushing the unknown wave toward the earlier side of the computational region, a vacant space in which there is no load peak data is formed on the later side of the computational region. In this embodiment, the processing unit 3 operates to insert newly-loaded load peak data into such a vacant space of the computational region, as illustrated on the lower right side of FIG. 15. That is, the processing unit 3 operates to generate a new computational region filled with Nₐₗₗ pieces of load peak data. Then, the processing unit 3 operates to analyze the load peak data within the newly-generated computational region by the rainflow method again, i.e., repeatedly preform the processing illustrated in FIGS. 14 and 15, particularly, in real time.

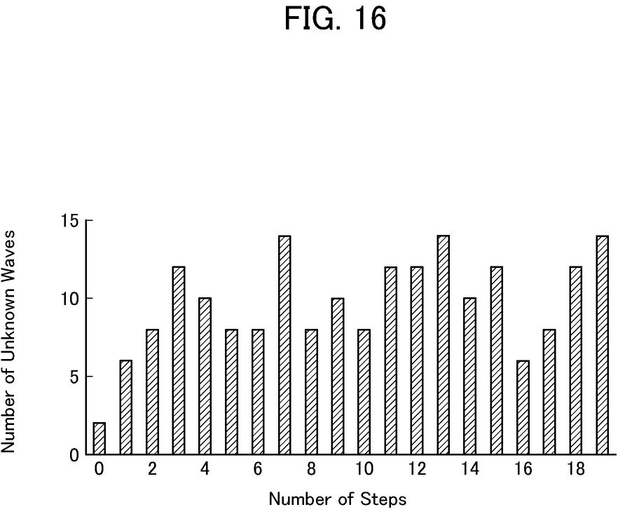

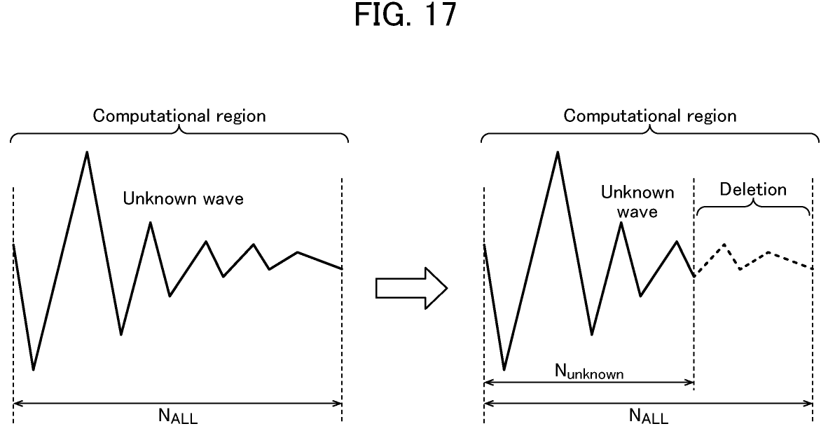

Here, the number of unknown waves does not continue to increase, but repeats increase and decrease. Thus, storing unknown waves does not unilaterally place a burden on the memory 3b. FIG. 16 illustrates a specific example of the number of unknown waves occurring in each step, in the load data analysis method according to this embodiment. FIG. 16 illustrates the number of unknown waves in each step. FIG. 16 shows that the number of unknown waves increases or decreases depending on steps. Thus, it can be said that the unknown wave does not place a burden on the memory 3b.

FIG. 17 is an explanatory diagram regarding an upper limit of the number of pieces of load data (the number of pieces of load peak data) of an unknown wave, in the load data analysis method according to this embodiment. On example of an unknown wave within the computational region is illustrated on the left side of FIG. 17. Here, a case is exemplified in which as a result of repeating the processing illustrated in FIGS. 14 and 15, the number of pieces of load peak data constituting the unknown wave reaches Nₐₗₗ. In this case, the computational region is filled with the Nₐₗₗ pieces of load peak data constituting the unknown wave, so that it becomes impossible to load new load peak data. That is, it is impossible to insert new load peak data into a vacant space of the computational region so as to generate a new computational region. Thus, in this embodiment, the processing unit 3 operates to, when the number of pieces of load peak data constituting the unknown wave is equal to or greater than N_{unknown} (which is equivalent to “limited amount” set forth in the appended claims; in one example, 31), a temporally later-acquired part of the N_{unknown} pieces or more of load peak data constituting the unknown wave is deleted, such that the number of pieces of the load peak data constituting the unknown wave becomes less than N_{unknown}, as illustrated on the right side of FIG. 17. That is, a part of the N_{unknown} pieces or more of load peak data constituting the unknown wave, on the later side of the computational region, is deleted to set the number of pieces of the load peak data constituting the unknown wave to less than N_{unknown}. In this case, the processing unit 3 operates to perform the deletion after collecting the load peak data to be subjected to deletion, in its current size.

In this embodiment configured as above, the number of pieces of the load peak data constituting the unknown wave is maintained to less than N_{unknown}, so that it is possible to reliably load new load peak data. Thus, new load peak data can be inserted into a vacant space of the computational region to generate a new computational region. Further, in this embodiment, a temporally later-acquired part of plural pieces of load peak data constituting the unknown wave is deleted, such that it is possible to minimally suppress an influence (error) due to the deletion of load peak data. This is because since the plural pieces of the load peak data constituting the unknown wave are arranged in descending order of the load amplitude (since an unknown wave is an attenuated wave), a part of the plural pieces of load peak data constituting the unknown wave, on the later side of the computational region, becomes smaller in terms of the load amplitude.

In this embodiment, with regard to plural pieces of load peak data constituting a known wave, the processing unit 3 operates to calculate a damage value from respective frequencies of the load amplitude and the load average, during the small loop and stopped wave collection (such a damage value calculated from a known wave will hereinafter be expressed as “damage value D_{known}”, as appropriate). In this case, the processing unit 3 operates to, every time processing is performed for each computational region, add a newly-calculated damage value D_{known} to a previous damage value D_{known}, i.e., update the damage value D_{known}. On the other hand, with regard to plural pieces of load peak data constituting an unknown wave, the processing unit 3 operates to collect (tentatively collect) the load peak data in its current size, and calculate a damage value (such a damage value calculated from an unknown wave will hereinafter be expressed as “damage value D_{unknown}”, as appropriate). In this case, the processing unit 3 operates to, every time processing is performed for each computational region, recalculate the damage value D_{unknown}. The processing unit 3 operates to add the damage value D_{known} and the damage value(s) D_{unknown} calculated in the above manner to calculate a current damage value (hereinafter expressed as “damage value Dₜₒₜₐₗ”, as appropriate).

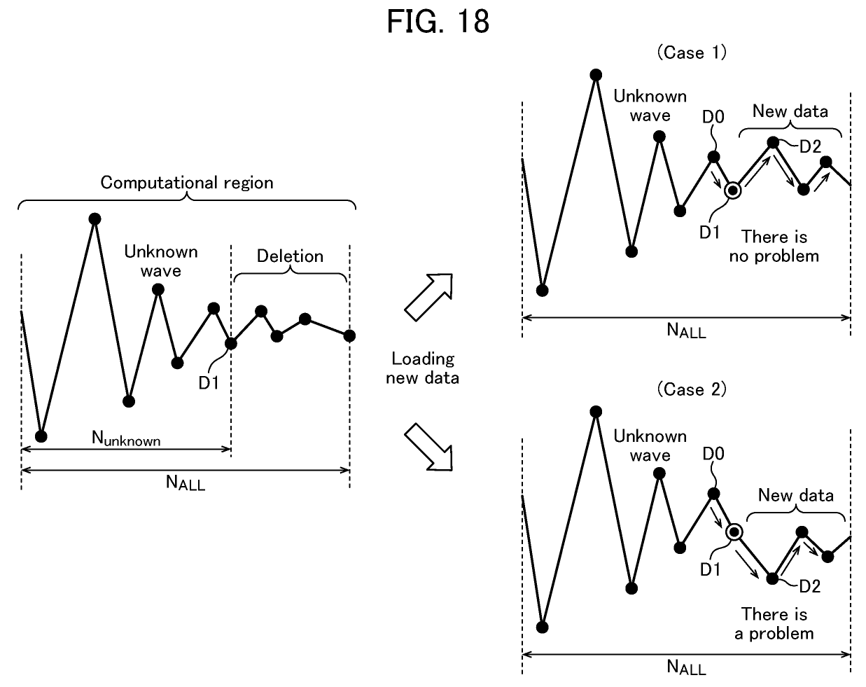

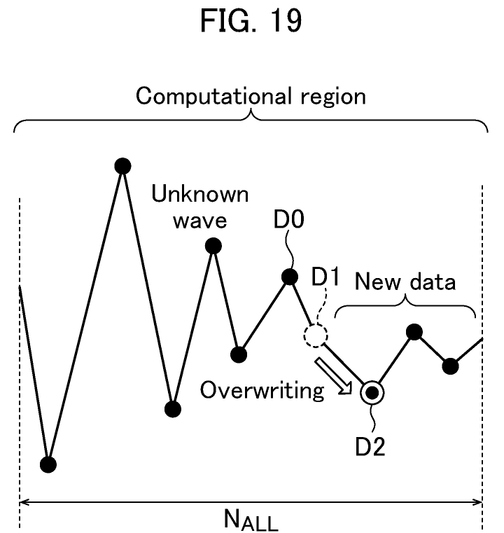

Next, with reference to FIGS. 18 and 19, a technique of connecting an unknown wave to new load peak data in the load data analysis method according to this embodiment will be described. Firstly, with reference to FIG. 18, a problem occurring when connecting an unknown wave to new load peak data will be described. An unknown wave in which the number of pieces of load peak data becomes N_{unknown} or more is exemplified on the left side of FIG. 18. In this case, the processing unit 3 operates to delete a temporally later-acquired part of plural pieces of load peak data constituting the unknown wave, such that the number of pieces of the load peak data constituting the unknown wave becomes less than N_{unknown}, as mentioned above. Then, the processing unit 3 operates to load new load peak date, and insert the new load peak date into a vacant space of a computational region. In this process, the processing unit 3 operates to connect load peak data D1 which is temporally latest in the unknown wave after the deletion of load peak data (the load peak data D1 will hereinafter be referred to as “first load peak data D1”) to load peak data D2 which is temporally earliest in the newly-loaded load peak data (the load peak data D2 will hereinafter be referred to as “second load peak data D2”).

In a case 1 illustrated on the upper right side of FIG. 18, a load waveform after the first load peak data D1 is connected to the second load peak data D2 is formed such that increasing and decreasing of the load peak data occur alternately. Specifically, a value from load peak data D0 just before the first load peak data D1 to the first load peak data D1 decreases (minus slope) and a value from the first load peak data D1 to the second load peak data D2 increases (plus slop), so that it can be said that a change in load peak data switches from decreasing to increasing after the first load peak data D1. The rainflow method can be properly applied to the case 1 where increasing and decreasing of load peak data occur alternately.

On the other hand, in a case 2 illustrated on the lower right side of FIG. 18, a load waveform after the first load peak data D1 is connected to the second load peak data D2 is formed such that increasing and decreasing of load peak data does not occur alternately. Specifically, a value from the load peak data D0 to the first load peak data D1 decreases (minus slope) and a value from the first load peak data D1 to the second load peak data D2 decreases (minus slop), so that it can be said that decreasing of load peak data continues before and after the first load peak data D1. The rainflow method cannot be properly applied to the case 2 where increasing and decreasing of load peak data does not occur alternately.

In this embodiment, when a load waveform after the first load peak data D1 is connected to the second load peak data D2 is formed such that increasing and decreasing of load peak data does not occur alternately, the processing unit 3 operates to overwrite the first load peak data D1 with the second load peak data D2, as shown in FIG. 19. In other words, the processing unit 3 operates to delete the first load peak data D1, and connect the load peak data D0 just before the first load peak data D1 to the second load peak data D2. Then, the processing unit 3 operates to use new load peak data overwritten in the above manner, as load peak data of a new computational region for performing next processing. Plural pieces of load peak data of such a new computational region have a load waveform in which increasing and decreasing of load peak data occur alternately, so that it becomes possible to properly utilize the rainflow method.

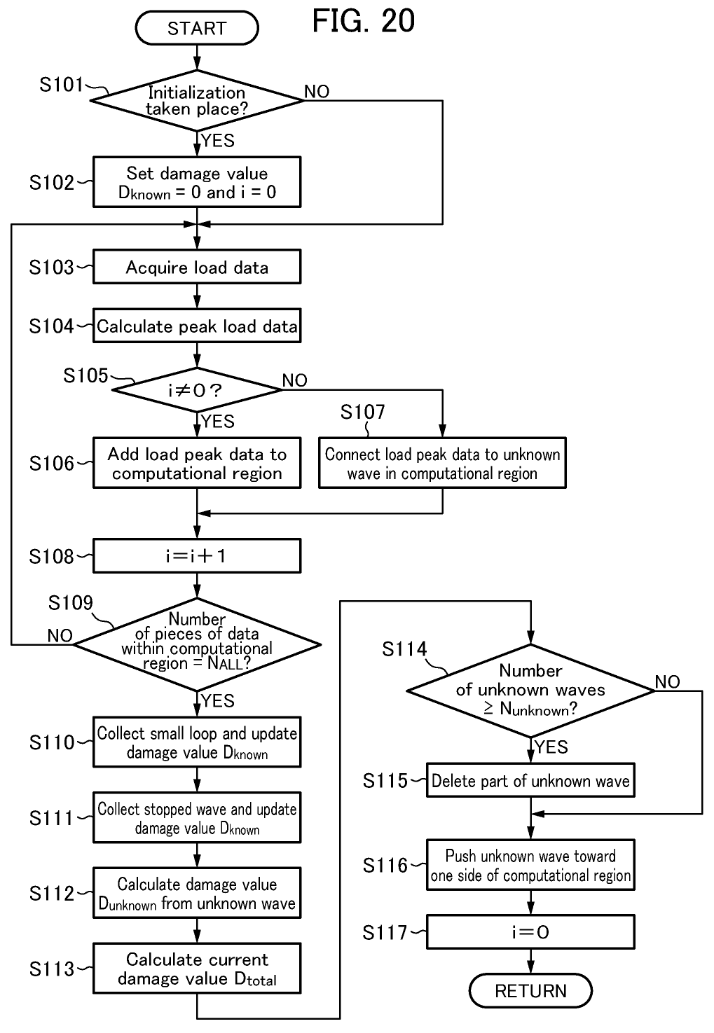

Next, with reference to FIG. 20, an overall flow of the load data analysis method according to this embodiment will be described. FIG. 20 is a flowchart showing the load data analysis method according to this embodiment. This flow is repeatedly executed by the processing unit 3 of the computer device 10 with a given period.

Firstly, in step S101, the processing unit 3 determines whether initialization has taken place. For example, in a case where the computer device 10 is mounted on a vehicle and configured to analyze a load applied to a given component of the vehicle, the initialization to be determined in the step S101 corresponds to data initialization to be performed at the time of shipment of the vehicle from a factory, or at an auto dealer, or initialization of the memory 3b for data gathering, in response to turning-off of an ignition system of the vehicle.

When it is determined that initialization has taken place (step S101: YES), the processing unit 3 proceeds to step S102. In the step S102, the processing unit 3 sets the damage value D_{known} for a known wave to “0”, and sets a variable i used for increment processing in this flow to “0”, i.e., initializes the damage value D_{known} and the variable i. Then, the processing unit 3 proceeds to step S103. On the other hand, when it is not determined that initialization has taken place (step S101: NO), the processing unit 3 proceeds to the step S103 without performing the processing in the step S102.

In the step S103, the processing unit 3 acquires load data corresponding to a load (mechanical load or stress, etc.) applied to a given object and detected by the load sensor 7. Then, in step S104, the processing unit 3 searches peak values from sequentially acquired load data, thereby calculating load peak data. Specifically, the processing unit 3 searches a point at which a change in the load waveform switches from increasing to decreasing, or from decreasing to increasing (peak value), thereby calculating load peak data.

Then, in step S105, the processing unit 3 determines whether the variable i is not 0. As a result, when it is determined that the variable i is not 0 (step S105: YES), the processing unit 3 proceeds to step S106, and in the step S106, adds the load peak data calculated in the step S104 to a computational region. On the other hand, when it is not determined that the variable i is not 0 (step S105: NO), i.e., when the variable i is 0, the processing unit 3 proceeds to step S107, and in the step S107, connects the load peak data calculated in the step S104 to an unknown wave which already exists within the computational region. Specifically, the processing unit 3 connects the load peak data calculated in the step S104 to load peak date which is temporally latest (at a tail end) in the unknown wave.

Then, in step S108, the processing unit 3 increments the variable i (i = i + 1). Then, in step S109, the processing unit 3 determines whether the number of pieces of load peak data within the computational region has become Nₐₗₗ, i.e., whether the computational region has been filled with the Nₐₗₗ pieces of load peak data. As a result, when it is determined that the number of pieces of load peak data within the computational region has become Nₐₗₗ (step S109: YES), the processing unit 3 proceeds to step S110. On the other hand, when it is not determined that the number of pieces of load peak data within the computational region has become Nₐₗₗ (step S109: NO), the processing unit 3 returns to the step S103, and carries out the processing in and after the step S103 again.

Then, in the step S110, with regard to the Nₐₗₗ pieces of load peak data within the computational data, the processing unit 3 identifies small loops using the small loop condition “| r₁ | > | r₂ | ≤ | r₃ |” regarding the relationship among adjacent three PV differences r₁, r₂, r₃, and collects the identified small loops. Specifically, based on load peak data constituting the small loops, the processing unit 3 updates (accumulates) the load amplitude and load average histograms, and updates (accumulates) the damage value D_{known}.

Then, in step S111, with regard to the plural pieces of load peak data within the computational data after the small loop collection, the processing unit 3 identifies a stopped wave using the stopped wave condition “| r₂ | ≥ | r₁ |”, regarding the relationship between adjacent two PV differences r₁, r₂, and collects the identified stopped wave. Specifically, based on load peak data constituting the stopped wave, the processing unit 3 updates (accumulates) the load amplitude and load average histograms, and updates (accumulates) the damage value D_{known}.

Then, in step S112, the processing unit 3 calculates the damage value D_{unknown}, based on load peak data of an unknown wave within the computational region, which has not been collected as a stopped wave. Then, in step S113, the processing unit 3 adds the damage value D_{known} and the damage value(s) D_{unknown} together to calculate a current damage value Dₜₒₜₐₗ. The processing unit 3 may be configured to display the calculated current damage value Dₜₒₜₐₗ on a display unit serving as the output unit 5. The processing unit 3 may also be configured to simultaneously display the load amplitude and load average histograms. Further, the processing unit 3 may be configured to give an indication informing that the end of a fatigue life is approaching, when the damage value Dₜₒₜₐₗ is larger than a given value (e.g., 0.2 (20%)). In one example, the processing unit 3 may be configured to indicate a possibility of failure of a vehicle component or a need to replace a vehicle component.

It should be noted that when the Nₐₗₗ pieces of load peak data within the computational region are collected as a stopped wave, i.e., when no unknown wave occurs, the processing unit 3 may be configured to skip the steps S112 and S113. In this case, the damage value Dtotai becomes equal to the damage value D_{known}.

Then, in step S114, the processing unit 3 determines whether the number of pieces of load peak data of the unknown wave is equal to or greater than N_{unknown}. As a result, when it is determined that the number of pieces of load peak data of the unknown wave is equal to or greater than N_{unknown} (step S114: YES), the processing unit 3 proceeds to step S115. In the step S115, the processing unit 3 deletes a temporally later-acquired part of the N_{unknown} pieces or more of load peak data constituting the unknown wave, such that the number of pieces of load peak data constituting the unknown wave becomes less than N_{unknown}. More specifically, the processing unit 3 calculates a damage value D based on the load peak data to be subjected to deletion, and after adding this damage value D to the above damage value(s) D_{unknown}, deletes said load peak data. Then, the processing unit 3 proceeds to step S116. On the other hand, when it is not determined that the number of pieces of load peak data of the unknown wave is equal to or greater than N_{unknown} (step S114: NO), the processing unit 3 proceeds to step S116 without performing the processing in the step S115.

Then, in the step S116, the processing unit 3 pushes the load peak data of the unknown wave (load peak data of the unknown wave which is left without being deleted in the step S115) toward the earlier side of the computational region. Specifically, the processing unit 3 compresses the unknown wave toward the left end of the computational region. Then, the processing unit 3 proceeds to step S117, and in the step S117, sets the variable i to “0”, i.e., initializes the variable i. Subsequently, the processing unit 3 exits the flow illustrated in FIG. 20, and will carry out the processings in and after the step S101 again.

### Functions and Effects

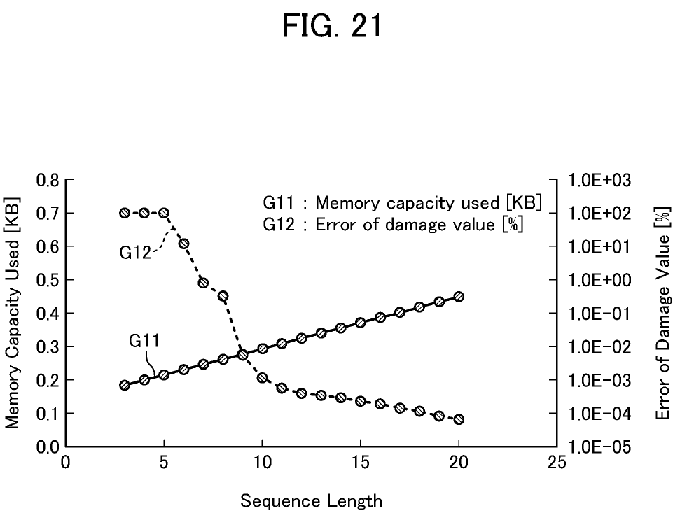

Next, with reference to FIGS. 21 to 23, functions and effects of the load data analysis method according to the above embodiment will be specifically described. FIGS. 21 to 23 show one example of results obtained when the load data analysis method according to the above embodiment is performed for the load waveform illustrated in FIG. 12.

Specifically, FIG. 21 shows: a memory capacity used (graph G11) in the load data analysis method according to the above embodiment, and an error of damage value (graph G12) in the load data analysis method according to the above embodiment, with respect to the conventional rail flow method (in which the entirety of load data is collected and then analyzed). In FIG. 21, the horizontal axis represents a sequence length corresponding to the computational region (i.e., the Nₐₗₗ pieces of load peak data constituting the computational region). As the sequence length becomes longer, the memory capacity used becomes larger naturally, but the error in damage value becomes smaller. In the graph G11, the memory capacity used is less than 1KB, which shows that the load data analysis method according to the above embodiment allows a memory capacity required for computation to be very small. Further, the graph G12 shows that the error in damage value in the load data analysis method according to the above embodiment is very small as compared with the conventional rainflow method, and can ensure computational accuracy substantially equal to that of the conventional rainflow method.

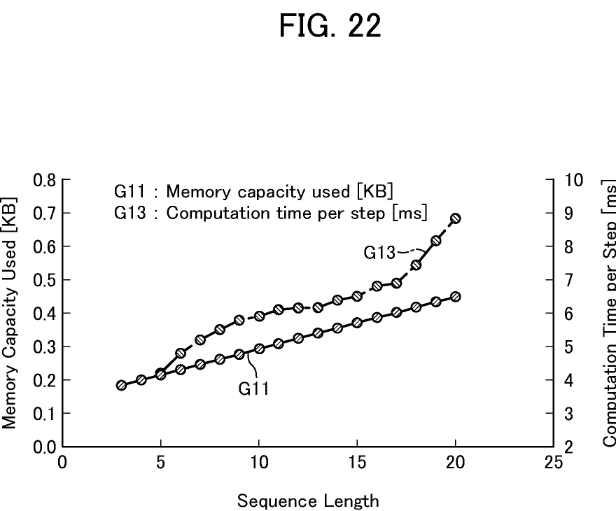

FIG. 22 shows a memory capacity used (graph G11) and a computation time per step (graph G13). In FIG. 22, the horizontal axis represents a sequence length, as with FIG. 21. In the graph G13, the computation time per step is less than 10 ms, which shows that the load data analysis method according to the above embodiment allows the computation time to be very short. The result illustrated in FIG. 22 was obtained in a debug mode (without conversion to machine language) at a relatively low computational speed.

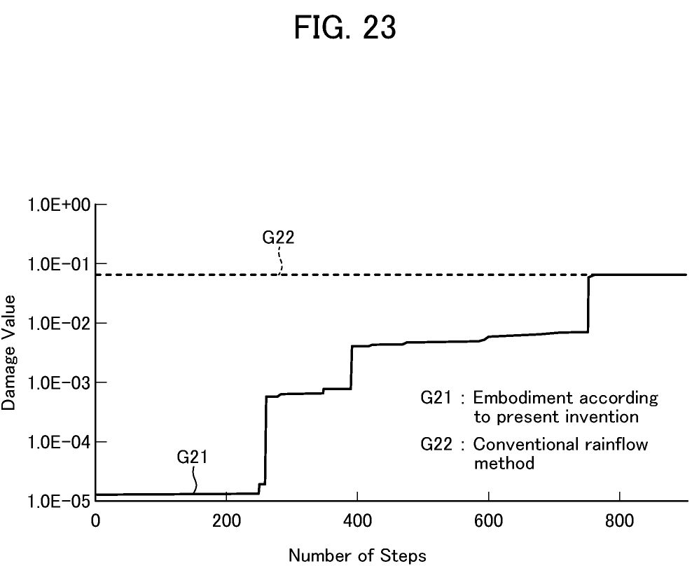

FIG. 23 shows a damage value in the load data analysis method according to the above embodiment (graph G21), and a damage value in the conventional rainflow method (graph G22). In FIG. 23, the horizontal axis represents the number of steps corresponding to an elapsed time from the start of computation. In the conventional rainflow method, the entirety of load data is collected and then analyzed, so that only a damage value in a final state of load data can be obtained (graph G22). By contrast, in the load data analysis method according to the above embodiment (wherein the Nₐₗₗ is set to 35), as shown in the graph G21, load data acquired from moment to moment is analyzed in real time, so that it is possible to obtain an intermediate history of damage value. Thus, it is possible to figure out at what timing the damage becomes greater. In addition, in the load data analysis method according to the above embodiment, a damage value in the later steps (about 800 steps) is coincident with the damage value in the final state in the conventional rainflow method. That is, the load data analysis method according to the above embodiment can ensure computational accuracy substantially equal to that of the conventional rainflow method.

Summarizing the above, the load data analysis method according to the above embodiment comprises:
(1) a first step of acquiring load data falling within a computational region, and calculating frequencies regarding a load amplitude and a load average, based on a rainflow method, using load data satisfying a stopped wave condition among the load data within the computational region;
(2) a second step of storing load data failing to satisfy the stopped wave condition among the load data within the computational region; and
(3) a third step of combining the load data stored in the second step with newly acquired load data to generate the load data falling within the computational region for carrying out the first step,
wherein the first to third steps are repeatedly carried out.

According to this feature, only the load data falling within the computational region is processed, instead of collecting load data over a long period of time and professing such a vast amount of load data, so that it is possible to realize reduction of memory capacity and shortening of computational time, when analyzing load data based on the rainflow method (FIGS. 21 and 22). Further, according to this feature, the load data satisfying the stopped wave condition is used for calculation of the frequencies, and the load data failing to satisfy the stopped wave condition is combined with newly-acquired load data to create load data filled in a new computational region, whereafter the load data within the new computational region is used for the next calculation of the frequencies, so that it is possible to analyze load data acquired from moment to moment in real time, while ensuring computational accuracy substantially equal to that of the conventional rainflow method (FIG. 23). As above, in the load data analysis method according to the above embodiment, it is possible to, when analyzing load data based on the rainflow method, adequately realize reduction of memory capacity (memory saving), shortening of computational time (high-speed computation) and real-time analysis, while ensuring computational accuracy substantially equal to that of the conventional rainflow method.

In the load data analysis method according to the above embodiment, the second step includes, when the number of pieces of the load data failing to satisfy the stopped wave condition among the load data within the computational region is equal to or greater than N_{unknown} (limit amount), deleting a part of the load data within the computational region such that the number of pieces of load data to be stored becomes less than N_{unknown}, and then storing the remaining load data after the deletion. According to this feature, the number of pieces of load data to be stored in the second step is maintained at less than N_{unknown}, so that it is possible to reliably load new load data. Thus, it is possible to enable combination with the new load data, thereby reliably generating a new computational region. Further, according to this feature, among the load data within the computational region, load data acquired temporally later, i.e., load data having a relatively small load amplitude, is deleted, so that it is possible to minimally suppress an influence (error) due to the deletion of load data.

In the load data analysis method according to the above embodiment, the third step includes, when a relationship between first load peak data which is temporally latest among load peak data corresponding to the load data stored in the second step and second load peak data which is temporally earliest among load peak data corresponding to the newly-acquired load data does not satisfy a condition that increasing and decreasing of the load peak data occur alternately, overwriting the first load peak data with the second load peak data to generate the load data falling within the computational region for carrying out the first step. According to this feature, it is possible to, when combining load data stored in the second step with the newly-acquired load data, adequately generate load data filled in a new computational region in which increasing and decreasing of the load data occur alternately, and utilize the rainflow method in an appropriate manner.

In the load data analysis method according to the above embodiment, the stopped wave condition used in the first and second steps is a condition that in adjacent two PV differences r₁, r₂ in a load waveform, the later PV difference r₂ is equal to or greater than the earlier PV difference r₁. According to this feature, it is possible to reliably apply load peak data having a relatively large load amplitude to calculation of the frequencies regarding the load amplitude and the load average.

The load data analysis method according to the above embodiment further comprises a fifth step of calculating a damage value of an object due to the load applied to the object, based on at least the frequencies calculated in the first step. According to this feature, it is possible to calculate a highly-accurate damage value in real time, while ensuring reduction of memory capacity and shortening of computational time.

The load data analysis method according to the above embodiment further comprises a sixth step of displaying the frequencies calculated in the first step or information related to the frequencies. According to this feature, it is possible to adequately inform a user of the frequencies regarding the load amplitude and the load average, the damage value or the like.

### Modifications

The above embodiment has been described based on an example where the present invention is applied to a vehicle. Alternatively, the present invention may be applied to any of various object to which a load is applied, such as electric appliances, ships or vessels, aircrafts and large buildings.

Further, the above embodiment has been described based on an example where the frequencies of both the load amplitude and the load average (histograms) are calculated. Alternatively, only one of the load amplitude and the load average (e.g., only the load amplitude) may be calculated. Further, although the above embodiment has been described based on an example where the damage value is calculated from such frequencies, the present invention is not limited to calculating the damage value.

What is claimed is:

1. A load data analysis method for analyzing load data indicative of a load irregularly and repeatedly applied to an object, based on a rainflow method, comprising:
a first step of acquiring a given amount of load data, and calculating a frequency/frequencies regarding an amplitude in a waveform of the load applied to the object and/or an average value of the load, by using load data satisfying a given condition among the given amount of load data, based on the rainflow method;
a second step of storing load data failing to satisfy the given condition among the given amount of load data; and
a third step of combining the load data stored in the second step with newly-acquired load data to generate the given amount of load data for executing the first step,
wherein the first to third steps are repeatedly executed.

2. The load data analysis method according to claim 1, wherein, in the second step, when an amount of the load data failing to satisfy the given condition among the given amount of load data is equal to or greater than a limit amount, a part of the given amount of load data is deleted such that an amount of load data to be stored becomes less than the limit amount, and then remaining load data after the deletion is stored.

3. The load data analysis method according to claim 2, wherein, in the second step, when the amount of the load data failing to satisfy the given condition among the given amount of load data is equal to or greater than the limit amount, a temporally later-acquired part of the given amount of load data is deleted such that an amount of load data to be stored becomes less than the limit amount.

4. The load data analysis method according to claim 1, further comprising a fourth step of calculating peak data corresponding to a point at which a change in the load data switches from increasing to decreasing, or from decreasing to increasing,
wherein, in the first to third steps, the peak data calculated in the fourth step is used as load data serving as a processing target in each step, and
wherein, in the third step, when a relationship between first peak data which is temporally latest among peak data corresponding to the load data stored in the second step and second peak data which is temporally earliest among peak data corresponding to the newly-acquired load data does not satisfy a condition that increasing and decreasing of the peak data occur alternately, the first peak data is overwritten with the second peak data to generate the given amount of load data for executing the first step.

5. The load data analysis method according to claim 2, further comprising a fourth step of calculating peak data corresponding to a point at which a change in the load data switches from increasing to decreasing, or from decreasing to increasing,
wherein, in the first to third steps, the peak data calculated in the fourth step is used as load data serving as a processing target in each step, and
wherein, in the third step, when a relationship between first peak data which is temporally latest among peak data corresponding to the load data stored in the second step and second peak data which is temporally earliest among peak data corresponding to the newly-acquired load data does not satisfy a condition that increasing and decreasing of the peak data occur alternately, the first peak data is overwritten with the second peak data to generate the given amount of load data for executing the first step.

6. The load data analysis method according to claim 3, further comprising a fourth step of calculating peak data corresponding to a point at which a change in the load data switches from increasing to decreasing, or from decreasing to increasing,
wherein, in the first to third steps, the peak data calculated in the fourth step is used as load data serving as a processing target in each step, and
wherein, in the third step, when a relationship between first peak data which is temporally latest among peak data corresponding to the load data stored in the second step and second peak data which is temporally earliest among peak data corresponding to the newly-acquired load data does not satisfy a condition that increasing and decreasing of the peak data occur alternately, the first peak data is overwritten with the second peak data to generate the given amount of load data for executing the first step.

7. The load data analysis method according to claim 1, further comprising a fourth step of calculating peak data corresponding to a point at which a change in the load data switches from increasing to decreasing, or from decreasing to increasing,
wherein, in the first to third steps, the peak data calculated in the fourth step is used as load data serving as a processing target in each step, and
wherein, in the first and second steps, with regard to adjacent peak data calculated in the fourth step, comprising first peak data, second peak data subsequent to the first peak data, and third peak data subsequent to the second peak data, a condition that a difference between the second peak data and the third peak data is equal to or greater than a difference between the first peak data and the second peak data is used as the given condition.

8. The load data analysis method according to claim 2, further comprising a fourth step of calculating peak data corresponding to a point at which a change in the load data switches from increasing to decreasing, or from decreasing to increasing,
wherein, in the first to third steps, the peak data calculated in the fourth step is used as load data serving as a processing target in each step, and
wherein, in the first and second steps, with regard to adjacent peak data calculated in the fourth step, comprising first peak data, second peak data subsequent to the first peak data, and third peak data subsequent to the second peak data, a condition that a difference between the second peak data and the third peak data is equal to or greater than a difference between the first peak data and the second peak data is used as the given condition.

9. The load data analysis method according to claim 3, further comprising a fourth step of calculating peak data corresponding to a point at which a change in the load data switches from increasing to decreasing, or from decreasing to increasing,
wherein, in the first to third steps, the peak data calculated in the fourth step is used as load data serving as a processing target in each step, and
wherein, in the first and second steps, with regard to adjacent peak data calculated in the fourth step, comprising first peak data, second peak data subsequent to the first peak data, and third peak data subsequent to the second peak data, a condition that a difference between the second peak data and the third peak data is equal to or greater than a difference between the first peak data and the second peak data is used as the given condition.

10. The load data analysis method according to claim 4, further comprising a fourth step of calculating peak data corresponding to a point at which a change in the load data switches from increasing to decreasing, or from decreasing to increasing,
wherein, in the first to third steps, the peak data calculated in the fourth step is used as load data serving as a processing target in each step, and
wherein, in the first and second steps, with regard to adjacent peak data calculated in the fourth step, comprising first peak data, second peak data subsequent to the first peak data, and third peak data subsequent to the second peak data, a condition that a difference between the second peak data and the third peak data is equal to or greater than a difference between the first peak data and the second peak data is used as the given condition.

11. The load data analysis method according to claim 5, further comprising a fourth step of calculating peak data corresponding to a point at which a change in the load data switches from increasing to decreasing, or from decreasing to increasing,
wherein, in the first to third steps, the peak data calculated in the fourth step is used as load data serving as a processing target in each step, and
wherein, in the first and second steps, with regard to adjacent peak data calculated in the fourth step, comprising first peak data, second peak data subsequent to the first peak data, and third peak data subsequent to the second peak data, a condition that a difference between the second peak data and the third peak data is equal to or greater than a difference between the first peak data and the second peak data is used as the given condition.

12. The load data analysis method according to claim 6, further comprising a fourth step of calculating peak data corresponding to a point at which a change in the load data switches from increasing to decreasing, or from decreasing to increasing,
wherein, in the first to third steps, the peak data calculated in the fourth step is used as load data serving as a processing target in each step, and
wherein, in the first and second steps, with regard to adjacent peak data calculated in the fourth step, comprising first peak data, second peak data subsequent to the first peak data, and third peak data subsequent to the second peak data, a condition that a difference between the second peak data and the third peak data is equal to or greater than a difference between the first peak data and the second peak data is used as the given condition.

13. The load data analysis method according to claim 1, further comprising a fifth step of calculating a damage value of the object due to the load applied to the object, based on at least the frequency/frequencies calculated in the first step.

14. The load data analysis method according to claim 12, further comprising a fifth step of calculating a damage value of the object due to the load applied to the object, based on at least the frequency/frequencies calculated in the first step.

15. The load data analysis method according to claim 1, wherein the method is executed by a processing unit mounted on a vehicle to analyze load data corresponding to a load applied to a component of the vehicle.

16. The load data analysis method according to claim 14, wherein the method is executed by a processing unit mounted on a vehicle to analyze load data corresponding to a load applied to a component of the vehicle.

17. The load data analysis method according to claim 1, further comprising a sixth step of displaying the frequency/frequencies calculated in the first step or information related to the frequency/frequencies.

18. The load data analysis method according to claim 16, further comprising a sixth step of displaying the frequency/frequencies calculated in the first step or information related to the frequency/frequencies.

19. A load data analysis device for analyzing load data corresponding to a load irregularly and repeatedly applied to an object, based on a rainflow method, the load data analysis device is configured to execute processing comprising:
a first step of acquiring a given amount of load data, and calculating a frequency/frequencies regarding an amplitude in a waveform of the load applied to the object, and/or an average value of the load, by using load data satisfying a given condition among the given amount of load data, based on the rainflow method;
a second step of storing load data failing to satisfy the given condition among the given amount of load data; and
a third step of combining the load data stored in the second step with newly-acquired load data to generate the given amount of load data for executing the first step,
wherein the first to third steps are repeatedly executed.

20. A load data analysis program to be executed by a computer device for analyzing load data corresponding to a load irregularly and repeatedly applied to an object, based on a rainflow method, the load data analysis program being configured to cause the computer device to execute processing comprising:
a first step of acquiring a given amount of load data, and calculating a frequency/frequencies regarding an amplitude in a waveform of the load applied to the object and/or an average value of the load, by using load data satisfying a given condition among the given amount of load data, based on the rainflow method;
a second step of storing load data failing to satisfy the given condition among the given amount of load data; and
a third step of combining the load data stored in the second step with newly-acquired load data to generate the given amount of load data for executing the first step,
wherein the first to third steps are repeatedly executed.
